(19) United States
(12) Patent Application Publication
(10) Pub. No.: US 2024/0186051 A1
(43) Pub. Date: Jun. 6, 2024

(54) TRANSFORMER INSTALLATION

(71) Applicant: Hitachi Energy Ltd, Zürich (CH)

(72) Inventors: Antonio NOGUES, Zaragoza (ES); Carlos ROY, Zaragoza (ES); Lorenz CEBRIAN, Zaragoza (ES); Victor Manuel GARCIA, Zaragoza (ES); Pilar MORATA, Zaragoza (ES); Fernando MUNOZ, Zaragoza (ES); Rafael MURILLO, Zaragoza (ES); Joel KERN, Raleigh, NC (US)

(21) Appl. No.: 18/285,249

(22) PCT Filed: Mar. 29, 2022
(86) PCT No.: PCT/EP2022/058284

§ 371 Date: Sep. 30, 2023

(30) Foreign Application Priority Data
Apr. 5, 2021 (EP) 21382279.4

(51) Int. Cl. H01F 27/10; H01F 27/28; H01F 27/32

(52) U.S. Cl. CPC H01F 27/105; H01F 27/2876; H01F 27/327; H01F 2027/328

(57) ABSTRACT

A transformer installation including at least one non-liquid immersed transformer having a magnetic core including at least two core legs each having a winding axis. The transformer further includes at least two coil windings wound around at least one of the core legs of the magnetic core about the winding axis. The transformer installation further includes at least one coil cooling tube defining a coil cooling channel for guiding a dielectric cooling fluid. The at least one cooling tube is wound about at least one of the at least two coil windings. The transformer installation further includes at least one core cooling channel arranged within the core. The core cooling channel is configured to guide a dielectric cooling fluid through the core.

### CROSS REFERENCE TO RELATED APPLICATIONS

This application is a 35 U.S.C. § 371 national stage application of PCT International Application No. PCT/EP2022/058284 filed on Mar. 29, 2022, which in turn claims foreign priority to European Patent Application No. 21382279.4, filed on Apr. 5, 2021, the disclosures and content of which are incorporated by reference herein in their entirety.

### BACKGROUND

A transformer converts electricity from a first voltage level to a second voltage level, wherein the second voltage level is either higher or lower than the first voltage level.

A transformer achieves such a voltage conversion by employing a primary coil winding and a secondary coil winding comprising electrical conductors. Each of the primary coil winding and secondary coil winding are wound around a ferromagnetic core by a plurality of turns.

The primary coil winding is connected to a source of voltage and the secondary coil winding is connected to a load. The ratio of turns in the primary coil winding to the turns in the secondary coil winding equals the ratio of the voltage level of the primary coil winding at the source of voltage to the voltage level of the secondary coil winding at the load.

The transformer may also comprise a plurality of primary coil windings and a plurality of secondary coil windings. Such transformers are referred to as multi-winding transformers. The plurality of primary coil windings and secondary coil windings, respectively, can be connected in series or in parallel. Furthermore, the plurality of primary coil windings and secondary coil windings, respectively, can also each be independent, i.e., unconnected, depending on the desired functionality of the transformer.

Transformers, such as of the types described above, are inadvertently heated during operation due to the power loss dissipated by the transformer in the form of heat. Such a power loss of the transformer comprises core losses and coil losses.

Thus, the core and the coil windings of the transformer generate heat within the transformer, which may be directed away from the transformer to achieve a better performance, a longer lifetime of the transformer and thus lower operational costs of the transformer.

It is known to immerse the coil windings and the core in a liquid, such as an oil, to insulate and cool the transformer. Transformers having such a cooling configuration are referred to as liquid immersed transformers.

As an alternative besides immersing the coil windings and the core in a liquid, it is also known to use a gas, such as air, to cool the coil windings of the transformer. In particular, a forced convection device can blow the cooling gas towards the coil windings to transfer heat from the windings to the cooling gas. Transformers having such a cooling configuration are referred to as non-liquid-immersed transformers or dry-type transformers since the core and the coil windings of such a transformer are not immersed in a liquid.

It is also known to arrange hollow conductors in the coil windings of the transformer. Water is forced to circulate through the interior of the hollow conductors. Other known solutions use metallic serpentines placed between the turns of a coil winding. In such cases, the metallic serpentine is grounded. Thus, the insulation between the turns and the serpentine has to withstand the voltage of the coil winding. Both of these solutions can only be used for low voltage transformers having a voltage of up to approximately 1 kV.

Hence, disadvantages remain in the prior art regarding the cooling of transformers.

For one, the cooling configurations using water, as described above, are only applicable to low voltage transformers. Thus, a solution for medium and high voltage transformers having voltages which are higher than approximately 1 kV has not yet been provided.

Moreover, there is a need to further improve the cooling of transformers in general in order to improve the performance and the lifetime of the transformer and to reduce its operational costs.

### SUMMARY

Therefore, it is an object of the present disclosure to provide improved cooling of a transformer, which can also be applied to medium and high voltage applications.

This object is achieved by a transformer installation defined by the features of claim 1.

Variations and further developments are defined by the features of the dependent claims.

The transformer installation comprises at least one non-liquid-immersed transformer comprising a magnetic core. The magnetic core comprises at least two core legs each having a winding axis. The non-liquid-immersed transformer further comprises at least two coil windings wound around at least one of the core legs, such as each of the core legs, of the magnetic core about the winding axis.

Within the context of the present application, a non-liquid immersed transformer is to be understood as a transformer whose core and coil windings are not immersed in a liquid. The non-liquid immersed transformer may or may not be immersed in a medium other than liquid, such as a gas, such as air. Such a transformer is also commonly referred to as a dry-type transformer.

The magnetic core may comprise more than two core legs, such as three, four or five core legs. Each of the core legs may have its own winding axis and may be configured as described herein.

The core may be made of a plurality of laminated sheets stacked together. The laminated sheets may be made of silicon steel or steel.

One coil winding of the at least two coil windings may be a primary coil winding connected to a source of voltage and a second core winding of the of the at least two coil windings may be a secondary coil winding connected to a load.

The at least two coil windings may be wound concentrically around the core leg of the magnetic core about the winding axis.

The transformer installation may further comprise at least one coil cooling tube defining a coil cooling channel for guiding a dielectric cooling fluid. The at least one cooling tube may be wound about at least one of the at least two coil windings. The transformer installation may further comprise at least one core cooling channel arranged within the core. The core cooling channel may be configured to guide a dielectric cooling fluid through the core.

By providing cooling of the at least two coil windings by means of the at least one coil cooling tube and of the core by means of at least one core cooling channel arranged within the core, a higher level of heat can be absorbed from the transformer and directed away from the transformer by the dielectric cooling fluid.

Thus, the performance and the lifetime of the transformer may be increased. Moreover, operational costs, such as frequent services, repairs and replacing parts, may be reduced.

Moreover, the cooling configuration described herein can also be used for medium and high voltage transformers. Hence, the field of application of the cooling configuration described herein is broader than in the prior art and can be universally employed for a wider range of voltage applications, i.e., low voltage, medium voltage and high voltage transformers.

Low voltage transformers are to be understood as transformers having a voltage of approximately 1 kV or less at either the source of voltage, i.e., at the primary coil winding, or at the load, i.e., at the secondary coil winding. Medium and high voltage transformers are to be understood as transformers having a voltage which is higher than approximately 1 kV at either the source of voltage, i.e., at the primary coil winding, or at the load, i.e., at the secondary coil winding.

The at least one cooling tube may be wound continuously about at least one of the at least two coil windings. Alternatively, the at least one cooling tube may be wound about at least one of the at least two coil windings only section-wise. In sections of the at least one cooling tube which are not continuously wound about at least one of the at least two coil windings the at least one cooling tube may, for instance, extend in a direction which is parallel to the winding axis.

The at least one cooling tube may be made of a dielectric material.

A first of the at least two coil windings, such as the primary coil winding, may be wound at least partially within a second of the at least two coil windings, such as the secondary coil winding. In this case, the first of the at least two coil windings is arranged closer to the winding axis than the second of the at least two coil windings.

In case of such a configuration, the at least one cooling tube may be arranged between the first and second coil windings and around the first coil winding with respect to the winding axis.

In some embodiments, however, at least two cooling tubes may be provided, wherein a first of the at least two cooling tubes may be arranged between the first and second coil windings, i.e. within the second coil winding, and a second of the at least two cooling tubes may be arranged around the second coil winding with respect to the winding axis. The cooling tubes may merge downstream to a single cooling conduit.

Arranging the cooling tubes in such a manner may allow for a high level of high transfer from the coil windings.

The at least one core cooling channel arranged within the core may be a separate element, such as a pipe, attached to or inserted into the core. Alternatively or additionally, the core cooling channel may be integrally formed within the core.

The core cooling channel may extend at least section-wise substantially in a direction which is parallel to the winding axis. Alternatively or additionally, the core cooling channel may extend at least section-wise substantially in a direction which is transverse to the winding axis.

The core cooling channel may be configured to direct the dielectric cooling fluid in a first direction which is substantially parallel to the winding axis and, at a section of the core cooling channel downstream therefrom, the core cooling channel may be configured to direct the dielectric cooling fluid in a second direction which is substantially parallel to the winding axis and which is substantially opposite to the first direction.

Alternatively or additionally, the core cooling channel may be configured to direct the dielectric cooling fluid in a first direction which is substantially transverse to the winding axis and, at a section of the core cooling channel downstream therefrom, the core cooling channel may be configured to direct the dielectric cooling fluid in a second direction which is substantially transverse to the winding axis and which is substantially opposite to the first direction.

Within the context of the present invention, either the at least one coil cooling tube or the at least one core cooling channel may be omitted. A sufficient cooling may be achieved with either the at least one coil cooling tube or the at least one core cooling channel. Having both the at least one coil cooling tube and the at least one core cooling channel is optional.

The transformer installation may comprise at least two coil cooling tubes for guiding a dielectric cooling fluid. A first of the at least two coil cooling tubes may be wound about a primary coil winding of the at least two coil windings and a second of the at least two coil cooling tubes may be wound about a secondary coil winding of the at least two coil windings.

As described above, one of the primary coil winding and secondary coil winding, such as the primary coil winding, may be wound at least partially within the other of the primary coil winding and secondary coil winding, such as the secondary coil winding.

In case of such a configuration, the first of the at least two coil cooling tubes may be wound about the primary coil winding, but within the secondary coil winding with respect to the winding axis. The second of the at least two coil cooling tubes may be wound about the secondary coil winding.

Thus, the first of the at least two coil cooling tubes may be arranged closer to the winding axis than the second of the at least two coil cooling tubes.

The at least two coil cooling tubes may be fluidically connected, e.g., by merging downstream into a single cooling conduit. The at least two coil cooling tubes may alternatively be fluidically disconnected from each other.

The two coil cooling tubes may merge to guide the dielectric cooling fluid from the at least two coil cooling tubes in a common dielectric cooling fluid path.

This allows the dielectric cooling fluid from the coil cooling tubes to be guided efficiently and in a space-saving manner in a single dielectric cooling fluid path, for instance to a heat exchanging device.

The core cooling channel may be arranged in at least one of the core legs such that the dielectric cooling fluid is guided in a direction substantially along the winding axis of the core leg.

Each of the core legs may have a core cooling channel arranged at least partially therein.

The transformer installation may comprise a plurality of core cooling channels distributed in the core.

This enhances the cooling effect of the core by increasing the heat transfer surface between the core cooling channels and the core. Thus, more heat can be absorbed by the dielectric cooling fluid to reduce the temperature within the core.

The core may comprise at least one transverse section connecting the core legs. At least one core cooling channel may be arranged in each of the core legs and at least one core cooling channel may be arranged in each transverse section.

Each of the core legs may be configured such as the core leg described above.

The core legs may be arranged such that the winding axes of the core legs may be substantially parallel to each other.

The transverse section may be arranged substantially at a 90° angle to the winding axes of the core legs.

The core may comprise at least two transverse sections, each connecting the core legs.

A magnetic flux may be generated through the core legs and the transverse section(s) by the coil windings.

By arranging at least one core cooling channel in each of the core legs and in each transverse section, the core may be cooled throughout a large portion thereof. This may also lead to an increased heat transfer from the core and a more even temperature distribution within the core since cooling is provided throughout most, if not all, sections of the core, namely at least in the transverse section(s) and the core legs.

The core cooling channel may be formed in a pipe arranged at least partially within the core.

By using a separate pipe, which is inserted into the core, rather than integrally forming the core cooling channel within the core, a wide range of readily available pipes having different cross-sections and/or materials can be used. Hence, the cooling configuration within the core can be modularly configured, for instance, by using different pipes having different cross-sections and/or materials based on the demands of a particular application.

The pipe may be made of metal, such as stainless steel, carbon steel, copper or aluminium. Metal provides good thermal conductivity for transferring the heat from the core to the dielectric cooling fluid.

At least one thermal conductivity element, such as a substantially planar pad, may be arranged within the core and adjacent to the pipe. The thermal conductivity element may abut the pipe. The thermal conductivity element may have a thermal conductivity of at least 0.5 W/m·K, at least 1 W/m·K, at least 21.5 W/m·K, at least 5 W/m·K, and/or at least 102 W/m·K.

Providing such a thermal conductivity element, such as a substantially planar pad, having a minimum level of thermal conductivity may enhance the heat transfer between the pipe and the core, e.g., by providing a larger contact surface between the pipe and the core.

For instance, in case the pipe has an outer surface which is not flat, such as in the case of a pipe with a circular cross-section, the outer surface of such a pipe would not properly match the surface of the core, e.g., one of the laminate sheets of the core, since the core typically has a flat surface.

Thus, the contact surface between the pipe and the core would be relatively small compared to a pipe which has a flat outer surface, such as a pipe with a rectangular cross-section.

Hence, providing a thermal conductivity element arranged within the core and adjacent to the pipe may increase the contact surface between the pipe and the core, which may increase the level of heat transfer from the core to the dielectric cooling fluid guided within the pipe.

The thermal conductivity element may be made of material which is compressible, such as by at least 5%, at least 10%, and/or at least 20% of its total volume. By allowing such compression of the thermal conductivity element, the contact between the pipe and the thermal conductivity element may be increased by allowing the thermal conductivity element to conform to the surfaces of the pipe and/or the core.

The transformer installation may comprise a plurality of pipes arranged within the core. Each pipe may define a core cooling channel. At least some of the plurality of pipes may be fluidically interconnected via connecting elements.

Arranging a plurality of pipes within the core may increase the level of heat transfer from the core to the dielectric cooling fluid guided within the pipe by increasing the heat transfer surface between the core and the dielectric cooling fluid guided within the pipes.

The core cooling channel may have, at least section-wise, a rectangular cross-sectional shape. The core cooling channel may have an oblong rectangular cross-sectional shape.

A rectangular cross-sectional shape, such as an oblong rectangular cross-sectional shape, of the core cooling channel may provide a relatively large ratio of heat transfer surface between the dielectric cooling fluid guided in the core cooling channel to the total volume of the dielectric cooling fluid guided in the core cooling channel.

Thus, the level and efficiency of heat transfer from the core to the dielectric cooling fluid guided within the core cooling channel may be increased.

Alternatively or additionally, the core cooling channel may have, at least section-wise, a circular cross-sectional shape.

Core cooling channels having a circular cross-sectional shape may also provide sufficient cooling characteristics. A bundle of pipes, each pipe defining a core cooling channel having a circular cross-sectional, may be employed in the core.

The coil cooling channel and the core cooling channel may merge to guide the dielectric cooling fluid in a common dielectric cooling fluid path.

By merging the coil cooling channel and the core cooling channel the dielectric cooling fluid from the coil cooling channel and from the core cooling channel may be guided in a single dielectric cooling fluid path, for instance to a heat exchanging device.

The transformer installation may further comprise at least one heat exchanging device fluidically connected to the transformer. The at least one heat exchanging device may be configured to dissipate heat absorbed from the transformer by the dielectric cooling fluid by allowing at least a portion of the dielectric cooling fluid to pass through the heat exchanging device. The heat exchanging device may be arranged outside of and distinct from the transformer.

The transformer installation may further comprise at least one coolant feed pipe for guiding at least a portion of the dielectric cooling fluid from the transformer to the heat exchanging device and at least one coolant return pipe for returning the dielectric cooling fluid from the heat exchanging device to the transformer.

The heat exchanging device may be an indirect heat exchanger.

The heat exchanging device may be a shell and tube heat exchange, a tube in tube heat exchanger, a plate heat exchanger, a plate fin heat exchanger, a plate and shell heat exchanger or a double tube heat exchanger.

By arranging the heat exchanging device outside of and distinct from the transformer, the heat dissipated from the heat exchanging device may be dissipated to the environment rather than within or towards the transformer. This may reduce the temperature of the ambient surrounding the transformer.

The transformer may be arranged in a first ambient and the heat exchanging device may be configured to dissipate the heat absorbed from the transformer by the dielectric cooling fluid to a second ambient which is different from the first ambient.

By dissipating the heat absorbed from the transformer by the dielectric cooling fluid to a different ambient than the ambient in which the transformer is arranged, a cooler environment may be provided around the transformer. This may further reduce the temperature within the transformer.

The first ambient and the second ambient may be substantially, such as completely, separated from each other by at least one barrier, such as by a wall.

The barrier may prevent or at least reduce atmospheric exchange between the first ambient and the second ambient.

The barrier may be an active element, such as an air curtain arranged between the first ambient to the second ambient or a suction device which may extract air from the first ambient and convey the air to the second ambient, or a passive element arranged between the first ambient to the second ambient, such as a wall or a shield.

Separating the first ambient from the second ambient by means of the at least one barrier may more effectively reduce the temperature in the first ambient compared to the temperature in the second ambient, e.g., by shielding the transformer from the heat exchanging device by means of the at least one barrier.

This may also enable the space in which the transformer is arranged, i.e., the first ambient, to be reduced since the heat exchanging device may be arranged in a different space, i.e., the second ambient. In case the first ambient surrounding the transformer is actively temperature controlled, less space may need to be controlled with regards to, e.g., temperature, humidity, pressure and air volume surrounding the transformer and the heat exchanging device.

This may reduce the total ambient controlling efforts, e.g. additional ambient cooling efforts etc., of the ambient surrounding the transformer.

Thus, the desired ambient conditions within the first ambient may be generated more efficiently

The heating exchanging device may be arranged in a room of a building, such as a warehouse, and the transformer may be arranged in a different room of the building or outside of the building. In this case, the heat exchanging device and the transformer may be separated from each other by a wall of the building. The dielectric cooling fluid may be guided from the transformer to the heat exchanging device via at least one coolant feed pipe which may be guided through the barrier, e.g., through the wall. At least one coolant return pipe for returning the dielectric cooling fluid from the heat exchanging device to the transformer may also be guided through the barrier, e.g., through the wall.

The first ambient may differ from the second ambient in at least one of the following: temperature, humidity, pressure and air volume surrounding the transformer and the heat exchanging device, respectively.

By providing two different ambients, i.e. the first ambient and the second ambient, the environmental parameters, such as temperature, humidity, pressure and air volume surrounding the transformer and the heat exchanging device, may be maintained and/or controlled separately for each ambient.

The transformer installation may comprise a plurality of non-liquid immersed transformers. Each transformer may be connected, such as in parallel with each other, to the heat exchanging device via the coolant feed pipe and the coolant return pipe.

Thus, the cooling of a plurality of transformers may be conducted efficiently by transferring the heat absorbed from the plurality of transformers to a single heat exchanging device, where the heat may be dissipated to the environment.

The transformers may also be arranged and connected to the heat exchanging device in series with each other.

The heat exchanging device may be of a liquid-to-air type. However, the heat exchanging device may alternatively be a liquid-to-liquid type.

The transformer installation may comprise at least one intermediate heat exchanging device arranged outside of the transformer. The at least one intermediate heat exchanging device may be fluidically connected to the heat exchanging device and the transformer.

The intermediate heat exchanging device may be configured to transfer heat absorbed from the transformer by the dielectric cooling fluid to a transfer medium and guide the transfer medium to the heat exchanging device to dissipate heat absorbed from the transformer to the environment.

Thus, the transformer and the intermediate heat exchanging device may be interconnected via a first cooling circuit and the intermediate heat exchanging device and the heat exchanging device may be interconnected via a second cooling circuit.

The first circuit may comprise the dielectric cooling fluid and the second circuit may comprise the transfer medium. The transfer medium may also be a dielectric cooling fluid.

The intermediate heat exchanging device may be of a liquid-to-air or a liquid-to-liquid type.

By providing at least a second heat exchanging device, i.e., the intermediate heat exchanging device, the flexibility in arranging the heat exchanging devices may be increased.

For instance, the intermediate heat exchanging device may be arranged relatively close to the transformer since the heat absorbed by the dielectric cooling fluid may not be dissipated to the environment of the intermediate heat exchanging device.

Instead, the heat absorbed from the transformer by the dielectric cooling fluid may be transferred to a transfer medium, which may be guided to the heat exchanging device to dissipate heat absorbed from the transformer to the ambient of the heat exchanging device rather than the ambient of the intermediate heat exchanging.

The intermediate heat exchanging device may be arranged in the first ambient.

Thus, the intermediate heat exchanging device may be arranged in the same ambient as the transformer. This may allow the distance between the transformer and the intermediate heat exchanging device to be reduced. Thus, since the dielectric cooling fluid is guided from the transformer to the intermediate heat exchanging device to transfer the heat therebetween, the amount of dielectric cooling fluid may also be reduced.

This may reduce the operating costs of the transformer installation and the risk of leaks or spillages of the dielectric cooling fluid. The transfer medium may be selected as a lower quality fluid, since transfer medium may not have the same qualities as the dielectric cooling fluid, e.g., with regards to voltage exposure within the transformer.

The intermediate heat exchanging device may be of a liquid-to-liquid type.

The transformer installation may comprise a dielectric cooling fluid pump configured to pump the dielectric cooling fluid through the coil cooling tube and/or the core cooling channel.

The core cooling channel may comprise a plurality of deflecting elements extending into the core cooling channel. The deflecting elements may be configured to deflect the dielectric cooling fluid to prevent the dielectric cooling fluid from taking the shortest flow path through the core cooling channel.

Thus, the heat transfer from the transformer to the dielectric cooling fluid may be further increased.

The dielectric cooling fluid may be an ester fluid, a silicone fluid, a non-flammable fluid, a mineral oil or a natural oil.

The cooling tube may be made of plastic material selected from the group consisting of cross-linked polyethylene (PEX), polyphenylsulfone (PPSU), polybutylene (PB), polytetrafluoroethylene (PTFE) or silicone.

The transformer may be a three-phase transformer.

The core may be made of a plurality of sheets. The core cooling channel may be arranged between at least two of the plurality of sheets.

The core may comprise at least one spacing element arranged between at least two of the plurality of sheets to provide a predetermined spacing between the sheets.

### Aspects

The following list of aspects provides alternative and/or further features of the disclosure:
1. A transformer installation, comprising:
   at least one non-liquid immersed transformer, comprising:
      a magnetic core comprising at least two core legs each having a winding axis;
      at least two coil windings wound around at least one of the core legs, such
      as each of the core legs, of the magnetic core about the winding axis; and
   at least one core cooling channel arranged within the core, the core cooling channel being configured to guide a dielectric cooling fluid through the core.
2. The transformer installation according to aspect 1, comprising at least one coil cooling tube defining a coil cooling channel for guiding a dielectric cooling fluid, wherein the at least one cooling tube is wound about at least one of the at least two coil windings.
3. The transformer installation according to aspect 2, comprising at least two coil cooling tubes for guiding a dielectric cooling fluid, wherein a first of the at least two coil cooling tubes is wound about a primary coil winding of the at least two coil windings and a second of the at least two coil cooling tubes is wound about a secondary coil winding of the at least two coil windings.
4. The transformer installation according to aspect 3, wherein the two coil cooling tubes merge to guide the dielectric cooling fluid from the at least two coil cooling tubes in a common dielectric cooling fluid path.
5. The transformer installation according to any of the preceding aspects, wherein the core cooling channel is arranged in at least one of the core legs, such as each of the core legs, such that the dielectric cooling fluid is guided in a direction substantially along the winding axis of the core leg.
6. The transformer installation according to any of the preceding aspects, comprising a plurality of core cooling channels distributed in the core.
7. The transformer installation according to aspect 5, wherein the core comprises at least one transverse section connecting the core legs, wherein at least one core cooling channel is arranged in each of the core legs and at least one core cooling channel is arranged in each transverse section.
8. The transformer installation according to any of the preceding aspects, wherein the core cooling channel is formed in a pipe arranged at least partially within the core.
9. The transformer installation according to aspect 8, wherein the pipe is made of metal, such as stainless steel, carbon steel, copper or aluminium.
10. The transformer installation according to aspect 8 or 9, comprising at least one thermal conductivity element, such as a substantially planar pad, arranged within the core and adjacent to the pipe, the thermal conductivity element abutting the pipe, wherein the thermal conductivity element has a thermal conductivity of at least 0.5 W/m·K, such as at least 2 W/m·K, at least 5 W/m·K, and/or least 10 W/m·K.
11. The transformer installation according to any of the preceding aspects, comprising a plurality of pipes arranged within the core, wherein each pipe defines a core cooling channel and at least some of the plurality of pipes are fluidically interconnected via connecting elements.
12. The transformer installation according to any of the preceding aspects, wherein the core cooling channel has, at least section-wise, a rectangular cross-sectional shape, such as an oblong rectangular cross-sectional shape.
13. The transformer installation according to any of the preceding aspects, wherein the core cooling channel has, at least section-wise, a circular cross-sectional shape.
14. The transformer installation according to any of the preceding aspects, wherein the coil cooling channel and the core cooling channel merge to guide the dielectric cooling fluid in a common dielectric cooling fluid path.
15. The transformer installation according to any of the preceding aspects, further comprising at least one heat exchanging device fluidically connected to the transformer and configured to dissipate heat absorbed from the transformer by the dielectric cooling fluid by allowing at least a portion of the dielectric cooling fluid to pass through the heat exchanging device, wherein the heat exchanging device is arranged outside of and distinct from the transformer, and wherein the transformer installation further comprises at least one coolant feed pipe for guiding at least a portion of the dielectric cooling fluid from the transformer to the heat exchanging device and at least one coolant return pipe for returning the dielectric cooling fluid from the heat exchanging device to the transformer.
16. The transformer installation according to aspect 15, wherein the transformer is arranged in a first ambient and the heat exchanging device is configured to dissipate the heat absorbed from the transformer by the dielectric cooling fluid to a second ambient which is different from the first ambient.
17. The transformer installation according to aspect 16, wherein the first ambient and the second ambient are substantially, such as completely, separated from each other by at least one barrier, such as by a wall.
18. The transformer installation according to aspect 16 or 17, wherein the first ambient differs from the second ambient in at least one of the following: temperature, humidity, pressure and air volume surrounding the transformer and the heat exchanging device, respectively.
19. The transformer installation according to any of aspects 15 to 18, comprising a plurality of non-liquid immersed transformers, wherein each transformer is connected, such as in parallel with each other, to the heat exchanging device via the coolant feed pipe and the coolant return pipe.
20. The transformer installation according to any of aspects 15 to 19, wherein the heat exchanging device is of a liquid-to-air type.
21. The transformer installation according to any of aspects 15 to 20, comprising at least one intermediate heat exchanging device arranged outside of the transformer and fluidically connected to the heat exchanging device and the transformer, wherein the intermediate heat exchanging device is configured to transfer heat absorbed from the transformer by the dielectric cooling fluid to a transfer medium and guide the transfer medium to the heat exchanging device to dissipate heat absorbed from the transformer to the environment.
22. The transformer installation according to aspects 16 and 21, wherein the intermediate heat exchanging device is arranged in the first ambient.
23. The transformer installation according to aspect 21 or 22, wherein the intermediate heat exchanging device is of a liquid-to-liquid type.
24. The transformer installation according to any of aspects 2 to 4, comprising a dielectric cooling fluid pump configured to pump the dielectric cooling fluid through the coil cooling tube and/or the core cooling channel.
25. The transformer installation according to any of the preceding aspects, wherein the core cooling channel comprises a plurality of deflecting elements extending into the core cooling channel and configured to deflect the dielectric cooling fluid to prevent the dielectric cooling fluid from taking the shortest flow path through the core cooling channel.
26. The transformer installation according to any of the preceding aspects, wherein the dielectric cooling fluid is an ester fluid, a silicone fluid, a non-flammable fluid, a mineral oil or a natural oil.
27. The transformer installation according to any of aspects 2 to 4, wherein the cooling tube is made of plastic material selected from the group consisting of cross-linked polyethylene (PEX), polyphenylsulfone (PPSU), polybutylene (PB), polytetrafluoroethylene (PTFE) or silicone.
28. The transformer installation according to any of the preceding aspects, wherein the transformer is a three-phase transformer.
29. The transformer installation according to any of the preceding aspects, wherein the core is made of a plurality of sheets and the core cooling channel is arranged between at least two of the plurality of sheets.
30. The transformer installation according to aspect 29, wherein the core comprises at least one spacing element arranged between at least two of the plurality of sheets to provide a predetermined spacing between the sheets.

### BRIEF DESCRIPTION OF THE DRAWINGS

Embodiments of the present disclosure are further elucidated below with reference to the figures. The described embodiments do not limit the present disclosure.

FIG. 1 shows a schematic, partially sectional view of a transformer installation according to an embodiment of the disclosure;

FIG. 2 shows a perspective view of a pipe having a core cooling channel for use in a transformer installation according to a further embodiment of the disclosure;

FIG. 3 shows a sectional view of a core of a transformer of a transformer installation according to a further embodiment of the disclosure having a plurality of pipes as shown in FIG. 2;

FIG. 4 shows a sectional view of a core of a transformer of a transformer installation according to a further embodiment of the disclosure having a plurality of pipes as shown in FIG. 2;

FIG. 5 shows a sectional view of a core of a transformer of a transformer installation according to a further embodiment of the disclosure;

FIG. 6 shows a schematic view of a transformer installation according to a further embodiment of the disclosure.

### DETAILED DESCRIPTION

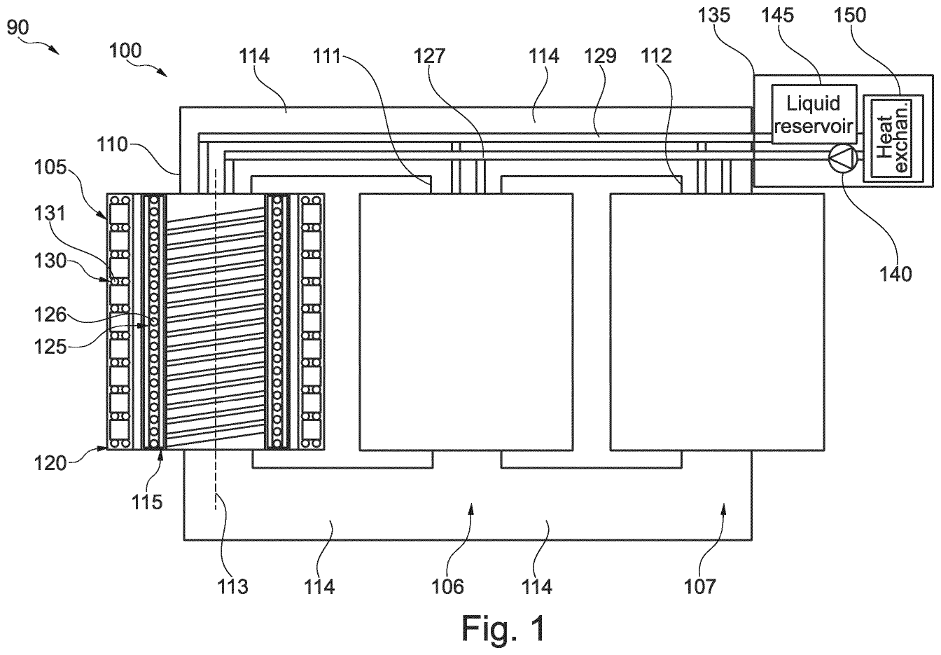

FIG. 1 shows a schematic and partially sectional view of a transformer installation 90 having a non-liquid immersed transformer 100 comprising a magnetic core 104 having three phases 105, 106 and 107. Each phase 105, 106 and 107 has a core leg 110, 111 and 112.

The core 104 may comprise more or less than three legs, for instance two, four or five legs.

Each core leg 110, 111 and 112 is connected to an adjacent core leg 110, 111 and 112, respectively, via transverse sections 114. The transverse sections 114 are arranged substantially at a 90° angle to a longitudinal axis of the core legs 110, 111 and 112.

For the sake of simplicity, the features of the present disclosure are described hereinafter based on the core leg 110 of the first phase 105.

It is understood that each core leg 111 and 112 of each of the other (e.g. two) phases 106 and 107 may also comprise the same or similar configuration of the core leg 110 of the first phase 105.

The core leg 110 has an inner coil winding 115 and an outer coil winding 120 wound around a winding axis 113 of the core leg 110. The inner coil winding 115 is arranged substantially within the outer coil winding 120, i.e., the inner coil winding 115 is arranged closer to the winding axis 113 than the outer coil winding 120. The inner coil winding 115 may be arranged completely or only partially within the outer coil winding 120.

The longitudinal axis of the core legs 110, 111 and 112 may substantially correspond to the winding axis 113.

One of the inner coil winding 115 and the outer coil winding 120 may be a primary coil winding connected to a source of voltage while the other of the inner coil winding 115 and the outer coil winding 120 may be a secondary coil winding connected to a load.

The inner coil winding 115 may be a low voltage (LV) winding surrounding the core 110. The inner coil winding 115 and/or the outer coil winding 120 may be a foil winding. The outer coil winding 120 may be a high voltage (HV) winding surrounding the inner coil winding 115.

The magnetic core 104 may be made of a plurality of laminated sheets stacked together. The laminated sheets may be made of silicon steel or steel.

The transformer 100 further comprises, exemplary, a first coil cooling tube 125 and a second coil cooling tube 130 each defining a coil cooling channel 126, 131. Each coil cooling tube 125, 130 guides a dielectric cooling fluid through the respective coil cooling channel 126, 131 to absorb heat generated by the inner coil winding 115 and the outer coil winding 120. The coil cooling tubes 125, 130 may be encapsulated in epoxy resin.

The coil cooling tubes 125, 130 may be made of a dielectric material, such as selected from the group consisting of cross-linked polyethylene (PEX), polyphenysulfone (PPSU), polybutylene (PB), polytetrafluoroethylene (PTFE) or silicone.

The first coil cooling tube 125 is wound forming one or more completed loops around the core leg 110, such as in a helical form, arranged substantially between the inner coil winding 115 and the outer coil winding 120.

The second cooling tube 130 is also wound forming one or more completed loops around the core leg 110, such as in a helical manner, passing through spaces in the outer coil winding 120.

Both of the coil cooling tubes 125, 130 may be continuously or discontinuously wound about the winding axis 113 of the core leg 110.

The first coil cooling tube 125 may be wound continuously about the winding axis 113 of the core leg 110 while the second coil cooling tube 130 may be wound discontinuously about the winding axis 113 of the core leg 110 or vice versa.

Further configurations of coil windings in connection with coil cooling tubes are disclosed in WO 2018/162568 A1 which is herewith incorporated by reference. It will be readily understood that the coil cooling tube construction and arrangement discussed above is exemplary and that other structures and arrangements may be chosen.

The coil cooling tubes 125, 130 may be connected to an external circuit 135. The external circuit comprises a pump 140, a heat-exchanging device 145 and a fluid reservoir 150, which is such as a liquid reservoir.

The pump 140 may supply a cooling fluid, such as a dielectric cooling liquid, from the reservoir 150 to the coil cooling tubes 125, 130 through a return pipe 127. The cooling fluid may then absorb heat from the coil windings 115, 120 as it passes through the cooling tubes 125 and 130.

The heated cooling fluid may then be fed back to the external circuit 135 through a feed pipe 129. The heat absorbed cooling fluid may then pass through a heat exchanging device 145 where the heat absorbed by the cooling fluid may be dissipated to the environment surrounding the heat exchanging device. The cooling fluid may then return to the liquid reservoir 150.

As indicated, the cooling fluid to be used in the cooling tubes may be any type of suitable dielectric fluid. For example, it can be an ester fluid, such as Midel®, Biotemp® or Envirotemp®. In other examples the dielectric fluid may be a silicone fluid, or a non-flammable fluid, such as a fluorinated fluid, such as Novec® or Fluorinert®, or a mineral or natural oil.

The transformer 100 may be arranged in a first ambient and the heat exchanging device 145 may be configured to dissipate the heat absorbed from the transformer 100 by the cooling fluid to a second ambient which is different from the first ambient.

By dissipating the heat absorbed from the transformer 100 by the cooling fluid via the heat exchanging device 145 to a different ambient than the ambient in which the transformer 100 is arranged, a cooler environment may be provided around the transformer 100. This may further reduce the temperature within the transformer 100.

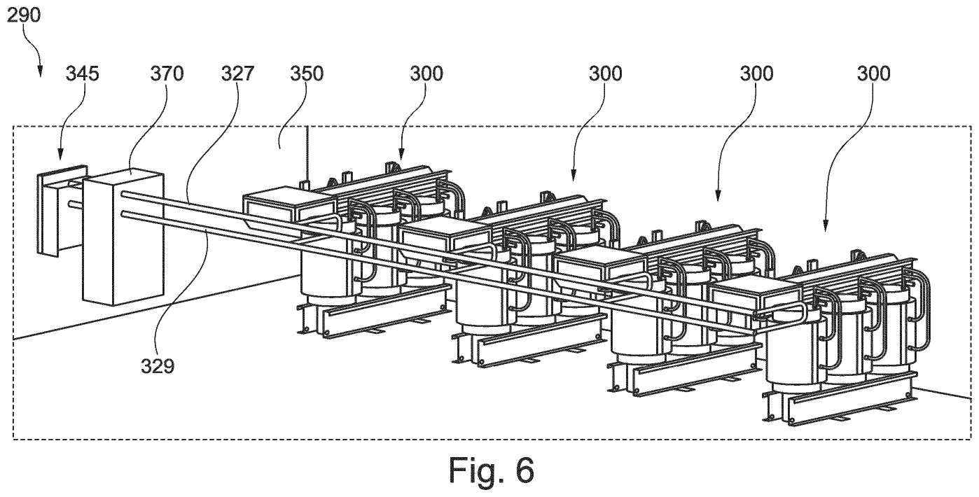

The first ambient and the second ambient may be substantially, such as completely, separated from each other by at least one barrier (see FIG. 6), such as by a wall. Separating the first ambient from the second ambient by means of the at least one barrier may more effectively reduce the temperature in the first ambient compared to the temperature in the second ambient by shielding the transformer 100 from the heat exchanging device 145 by means of the at least one barrier.

The heating exchanging device 145 may be arranged in a room of a building, such as a warehouse, and the transformer 100 may be arranged in a different room of the building or outside of the building. In this case, the heat exchanging device 145 and the transformer 100 may be separated from each other by a wall of the building.

The first ambient may differ from the second ambient in at least one of the following: temperature, humidity, pressure and air volume surrounding the transformer 100 and the heat exchanging device 145, respectively.

The transformer installation 90 may comprise at least one intermediate heat exchanging device (see FIG. 6) arranged outside of the transformer 100. Such an intermediate heat exchanging device may be fluidically connected to the main heat exchanging device 145 and the transformer 100.

The intermediate heat exchanging device may be configured to transfer heat absorbed from the transformer 100 by the cooling fluid to a transfer medium and guide the transfer medium to the heat exchanging device 145 to dissipate heat absorbed from the transformer 100 to the environment.

The transformer installation 90 may comprise a plurality of non-liquid immersed transformers 100 (see FIG. 6). In such a configuration, each transformer 100 may be connected, such as in parallel with each other, to the heat exchanging device 145 via the coolant feed pipe 129 and the coolant return pipe 127.

The transformer 100 shown in FIG. 1 may further comprise at least one core cooling channel arranged within the core 104. The core cooling channel may be configured to guide a dielectric cooling fluid through the core.

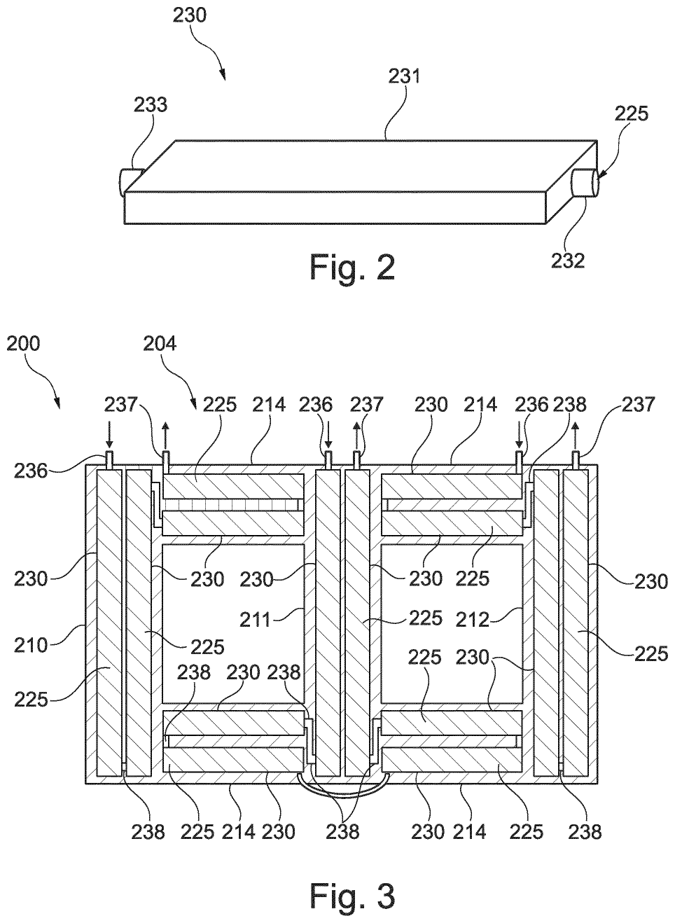

For the sake of clarity, such a core cooling channel is not shown in FIG. 1. Instead, an exemplary configuration of such a core cooling channel is shown in FIG. 2, as described below.

It is understood that the transformer installation 100 shown in FIG. 1 may also have such a core cooling channel having the features described below with respect to FIG. 2.

Likewise, the transformer installation shown in FIG. 2, referred to as transformer installation 200, may have the features shown in FIG. 1 and described above in connection with FIG. 1.

Thus, a transformer installation according to the present disclosure may have the coil cooling tubes 125, 130 and at least one core cooling channel, as described below. Thus, the present disclosure may have a combination of coil cooling tubes 125, 130 and one or more core cooling channels.

It is also understood that either the coil cooling tubes 125, 130 or the one or more core cooling channels may be omitted within the context of the present disclosure. A sufficient cooling may be achieved with either the cooling tubes 125, 130 or the one or more core cooling channels. While having the coil cooling tubes 125, 130 and the one or more core cooling channels in a single transformer installation may be advantageous, it is optional.

FIG. 2 shows a core cooling channel 225 formed in a pipe 230. The pipe 230 has a main flow body 231 into which cooling fluid, e.g., a dielectric cooling liquid, is introduced via an inlet 232 and out of which the cooling fluid is discharge via an outlet 233.

The main flow body 231 has a substantially oblong rectangular cross-sectional shape defining a core cooling channel 225 having a substantially oblong rectangular cross-sectional shape.

FIG. 3 shows a transformer 200 having a magnetic core 204 having three core legs 210, 211 and 212 with transverse sections 214 connecting the core legs 210, 211 and 212. A plurality of the pipes 230 shown in FIG. 2 and described above is arranged within the core 204. The pipes 230 are distributed throughout the core 204 in the core legs 210, 211 and 212 and in the transverse sections 214.

Some of the pipes 230 have inlets 236 and outlets 237 for introducing and discharging the cooling fluid into and out of the core 204.

Connecting elements 238 are also provided to fluidically interconnect the pipes 230 with each other.

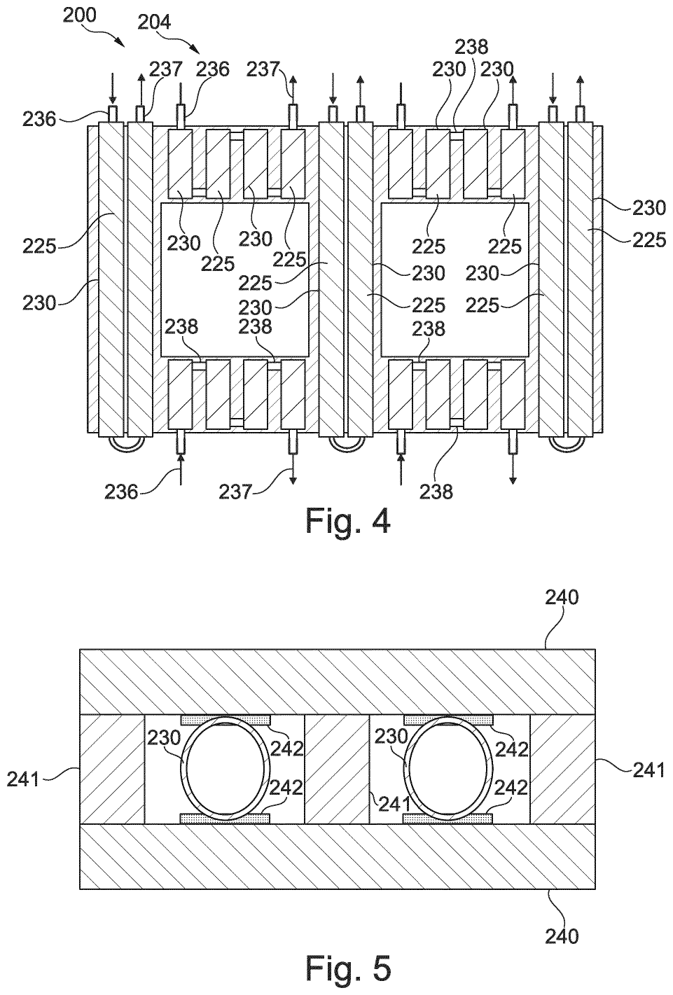

FIG. 4 shows a similar configuration of the transformer 200 shown in FIG. 3. The transformer 200 shown in FIG. 4 differs from the configuration shown in FIG. 3 in the arrangement of the pipes 230 within the core 204. For the sake of a better overview, not all of the parts shown in FIG. 4 are provided with reference signs. Some reference signs have been omitted.

In FIG. 3 the pipes 230 in the transverse section 214 are arranged such that the cooling fluid flows though the core cooling channels 225 of the pipes 230 substantially in a direction which is transverse to the longitudinal axis of the core legs 210, 211, 212.

The longitudinal axis of the core legs 210, 211, 212 may correspond to the winding axis 113 of the core legs 110, 111, 112 shown in FIG. 1.

In FIG. 4 the pipes 230 in the transverse section 214 are arranged such that the cooling fluid flows though the core cooling channels 225 of the pipes 230 substantially in a direction which is parallel to the longitudinal axis of the core legs 210, 211, 212.

At least some of the pipes 230 in the transverse section 214 and in the core legs 210, 211, 212 may alternatively be arranged at an angle between 0° and 90° to the longitudinal axis and/or to the winding axes of the core legs 210, 211, 212.

Alternatively, only the core legs 210, 211, 212 or only the transverse sections 214 may be provided with cooling channels 225. Thus, the cooling channels 225 may be omitted in either the core legs 210, 211, 212 or the transverse sections 214.

Alternatively or additionally, the cooling channels 225 may be defined integrally in the core 204, i.e., without using separate pipes which are inserted into the core 204, such as those described above. For instance, the core 204 may be made of a plurality of stacked elements, for instance sheets, which intrinsically define the cooling channels 225.

FIG. 5 shows alternatively configured pipes 230 each defining a core cooling channel 225. The core cooling channels 225 have a substantially circular cross-section shape.

The pipes 230 are arranged between individual core members 240 which form the core 204. Spacing elements 241 are arranged between the core members 240 to provide a predetermined spacing between the core members 240.

Thermal conductivity elements 242, configured as a substantially planar pads in the embodiment shown in FIG. 5, are also provided. The thermal conductivity elements 242 are arranged between one of the core members 240 and the pipe 230 adjacent thereto.

The thermal conductivity elements 242 each abut the respective pipe 230 and the respective core member 240. T

The thermal conductivity elements 242 may have a thermal conductivity of at least 0.5 W/m·K, at least 2 W/m·K, at least 5 W/m·K, and/or at least 10 W/m·K.

Providing such thermal conductivity elements 242 having a minimum level of thermal conductivity may enhance the heat transfer between the pipe 230 and the core 204, e.g., by providing a larger contact surface between the pipes 230 and the core member 240.

For instance, in the case of the pipes 230 shown in the embodiment of FIG. 5 having a circular cross-sectional shape, the outer surface of such a pipe 230 does not properly match the surface of the core, e.g., surface of the core members 240 facing the pipe 230.

Thus, the contact surface between the pipe 230 and the core member 240 is relatively small compared to a pipe which has a flat outer surface abutting the core member 240, such as the pipe with a rectangular cross-section as shown in FIG. 2.

Hence, providing the thermal conductivity element 242 arranged within the core 204 and adjacent to the pipes 230 may increase the contact surface between the pipes 230 and the core 204, which may increase the level of heat transfer from the core 204 to the cooling fluid guided within the pipes 230.

Thermal conductivity elements 242 may also be used for pipes with other cross-sectional shapes, for instance polygonal cross-sectional shapes, in order to increase the contact surface between the core 204, e.g., core members 240 of the core 204, and the pipes 230 to improve the heat transfer from the core 204 to the cooling fluid in the pipes 230.

FIG. 6 shows a transformer installation 290 with a plurality of transformers 300, which may be configured as transformers 100 and/or 200 shown in FIGS. 1 to 5 as described above.

The transformers 300 are connected, in parallel with each other, to a heat exchanging device 345 via a coolant feed pipe 329 and a coolant return pipe 327. The transformers 300 may alternatively be arranged in series with respect to each other.

The transformer installation 290 also includes cooling fluid supply equipment 370, such at least one pump for pumping the cooling fluid, at least one reservoir for storing cooling fluid and at least one controller for controlling the transformer installation 290, such as controlling the cooling fluid flow rate etc.

Each transformer 300 has its own intermediate heat exchanging device 360, such as arranged in close vicinity to each transformer 300.

Each intermediate heat exchanging device 360 is arranged outside of each transformer 300 and fluidically connected to the main heat exchanging device 345 via the coolant feed pipe 329 and the coolant return pipe 327.

Thus, the intermediate heat exchanging devices 360 transfer heat absorbed from each transformer 300 by a cooling fluid to a transfer medium which flows through the coolant feed pipe 329 and the coolant return pipe 327 to the main heat exchanging device 345 to dissipate heat absorbed from the transformers 300 to the environment

The transformers 300 and the intermediate heat exchanging devices 360 are arranged in a first ambient, e.g., a first room of a building.

The main heat exchanging device 345 dissipates the heat absorbed from the transformers 300 to a second ambient, e.g., a second room of a building, which is different from the first ambient.

The first ambient and the second ambient are separated from each other by a barrier 350, which is depicted as a wall separating the first ambient from the second ambient in FIG. 6. The coolant feed pipe 329 and the coolant return pipe 327 are guided from the first ambient through the wall 350 to the main heat exchanging device 345 in the second ambient.

By dissipating the heat absorbed from the transformers 300 by the dielectric cooling fluid to a different ambient than the ambient in which the transformers 300 are arranged, a cooler environment may be provided around the transformers 300. This may further reduce the temperature within the transformers 300.

Other barriers, other than the wall 350 shown in FIG. 5, may also be used. Any element which prevents or at least reduces atmospheric exchange between the first ambient and the second ambient may be employed.

For instance, a shield arranged between the first ambient and the second ambient can be provided as a barrier.

Furthermore, the barrier can be an active or a passive element. A passive element, such as a wall or shield, constantly separates the first ambient from the second ambient until the passive element is removed.

An active element, such as an air curtain arranged between the first ambient and the second ambient, which can be activated and deactivated, can alternatively or additionally be provided.

1. A transformer installation, comprising:
at least one non-liquid immersed transformer, comprising:
a magnetic core comprising at least two core legs each having a winding axis;
at least two coil windings wound around at least one of the core legs of the magnetic core about the winding axis;
at least one coil cooling tube defining a coil cooling channel for guiding a dielectric cooling fluid, wherein the at least one cooling tube is wound about at least one of the at least two coil windings; and
at least one core cooling channel arranged within the core, the core cooling channel being configured to guide a dielectric cooling fluid through the core.

2. The transformer installation according to claim 1, comprising at least two coil cooling tubes for guiding a dielectric cooling fluid, wherein a first of the at least two coil cooling tubes is wound about a primary coil winding of the at least two coil windings and a second of the at least two coil cooling tubes is wound about a secondary coil winding of the at least two coil windings.

3. The transformer installation according to claim 2, wherein the two coil cooling tubes merge to guide the dielectric cooling fluid from the at least two coil cooling tubes in a common dielectric cooling fluid path.

4. The transformer installation according to claim 1, wherein the core cooling channel is arranged in at least one of the core legs such that the dielectric cooling fluid is guided in a direction substantially along the winding axis of the core leg.

5. The transformer installation according to claim 1, comprising a plurality of core cooling channels distributed in the core.

6. The transformer installation according to claim 5, wherein the core comprises at least one transverse section connecting the core legs, wherein at least one core cooling channel is arranged in each of the core legs and at least one core cooling channel is arranged in each transverse section.

7. The transformer installation according to claim 1, wherein the core cooling channel is formed in a pipe arranged at least partially within the core.

8. The transformer installation according to claim 7, wherein the pipe is made of metal.

9. The transformer installation according to claim 7, comprising at least one thermal conductivity element, arranged within the core and adjacent to the pipe, the thermal conductivity element abutting the pipe, wherein the thermal conductivity element has a thermal conductivity of at least 0.5 W/m·K.

10. The transformer installation according to claim 1, comprising a plurality of pipes arranged within the core, wherein each pipe defines a core cooling channel and at least some of the plurality of pipes are fluidically interconnected via connecting elements.

11. The transformer installation according to claim 1, wherein the core cooling channel has, at least section-wise, a rectangular cross-sectional shape.

12. The transformer installation according to claim 1, wherein the core cooling channel has, at least section-wise, a circular cross-sectional shape.

13. The transformer installation according to claim 1, wherein the coil cooling channel and the core cooling channel merge to guide the dielectric cooling fluid in a common dielectric cooling fluid path.

14. The transformer installation according to claim 1, further comprising at least one heat exchanging device fluidically connected to the transformer and configured to dissipate heat absorbed from the transformer by the dielectric cooling fluid by allowing at least a portion of the dielectric cooling fluid to pass through the heat exchanging device, wherein the heat exchanging device is arranged outside of and distinct from the transformer, and wherein the transformer installation further comprises at least one coolant feed pipe for guiding at least a portion of the dielectric cooling fluid from the transformer to the heat exchanging device and at least one coolant return pipe for returning the dielectric cooling fluid from the heat exchanging device to the transformer.

15. The transformer installation according to claim 14, wherein the transformer is arranged in a first ambient and the heat exchanging device is configured to dissipate the heat absorbed from the transformer by the dielectric cooling fluid to a second ambient which is different from the first ambient.

16. The transformer installation according to claim 15, wherein the first ambient and the second ambient are substantially separated from each other by at least one barrier.

17. The transformer installation according to claim 15, wherein the first ambient differs from the second ambient in at least one of the following: temperature, humidity, pressure and air volume surrounding the transformer and the heat exchanging device, respectively.

18. The transformer installation according to claim 14, comprising a plurality of non-liquid immersed transformers, wherein each transformer is connected to the heat exchanging device via the coolant feed pipe and the coolant return pipe.

19. The transformer installation according to claim 14, wherein the heat exchanging device is of a liquid-to-air type.

20. The transformer installation according to claim 14, comprising at least one intermediate heat exchanging device arranged outside of the transformer and fluidically connected to the heat exchanging device and the transformer, wherein the intermediate heat exchanging device is configured to transfer heat absorbed from the transformer by the dielectric cooling fluid to a transfer medium and guide the transfer medium to the heat exchanging device to dissipate heat absorbed from the transformer to the environment.

21-29. (canceled)
